(19) United States
(12) Patent Application Publication
(10) Pub. No.: US 2023/0332267 A1
(43) Pub. Date: Oct. 19, 2023

(54) RECYCLING METHOD FOR MIXED WASTE MATERIAL OF LITHIUM NICKEL MANGANESE COBALT OXIDE AND LITHIUM IRON PHOSPHATE

(71) Applicants: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP EV RECYCLING CO., LTD., Changsha (CN)

(72) Inventors: Jinliang Duan, Foshan (CN); Changdong Li, Foshan (CN); Yang Xia, Foshan (CN); Yong Cai, Foshan (CN); Dingshan Ruan, Foshan (CN); Ruokui Chen, Foshan (CN)

(21) Appl. No.: 18/213,839

(22) Filed: Jun. 24, 2023

Related U.S. Application Data
(63) Continuation of application No. PCT/CN2022/093098, filed on May 16, 2022.

(30) Foreign Application Priority Data
Aug. 25, 2021 (CN) 202110980738.9

(51) Int. Cl. C22B 7/00; C22B 26/12; C22B 3/00; C22B 47/00

(52) U.S. Cl. CPC C22B 7/007; C22B 23/0415; C22B 23/0453; C22B 26/12; C22B 47/0063; C22B 47/0081

(57) ABSTRACT

The present disclosure discloses a recycling method for a mixed waste material of lithium nickel manganese cobalt oxide (LNMCO) and lithium iron phosphate (LFP), including: conducting acid-leaching to obtain an acid-leaching liquor with nickel, cobalt, manganese, phosphorus, iron, and lithium; conducting adsorption separation with a resin, washing the resin with sulfuric acid to obtain a mixed solution of nickel sulfate, cobalt sulfate, and manganese sulfate, and subjecting the mixed solution to precipitation to obtain an LNMCO cathode material precursor; and subjecting an obtained solution with phosphorus, iron, and lithium to lithium precipitation to obtain a lithium salt precipitate, and subjecting a post-precipitation solution to concentration and electrospinning to obtain a ferric phosphate/carbon material. The process of the present disclosure can achieve comprehensive recycling of a mixed waste material of LNMCO and LFP and the directed circulation of waste LNMCO and LFP materials.

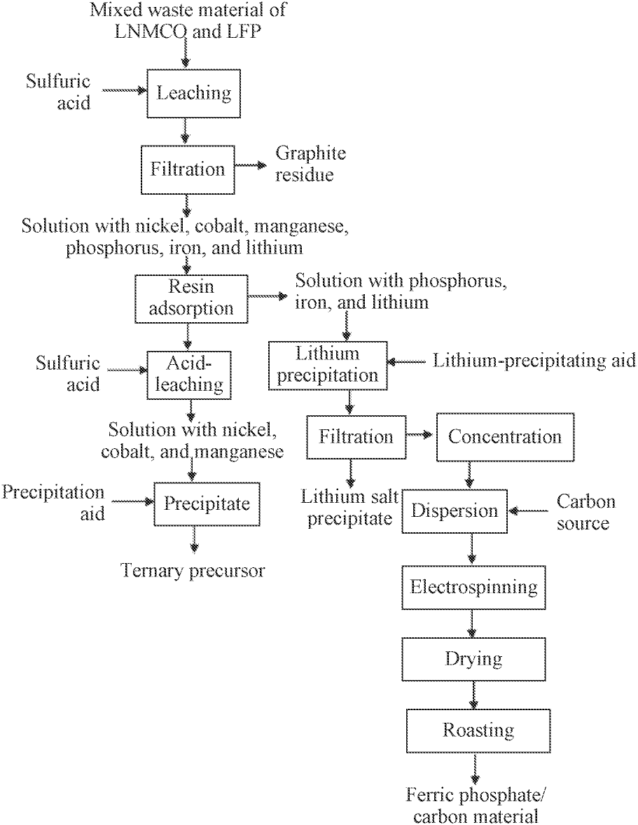

### CROSS-REFERENCE TO RELATED APPLICATIONS

The present application is a continuation application of PCT application No. PCT/CN2022/093098 filed on May 16, 2022, which claims the benefit of Chinese Patent Application No. 202110980738.9 filed on Aug. 25, 2021. The contents of all of the aforementioned applications are incorporated by reference herein in their entirety.

### TECHNICAL FIELD

The present disclosure belongs to the technical field of recycling of waste battery materials, and specifically relates to a recycling method for a mixed waste material of lithium nickel manganese cobalt oxide (LNMCO) and lithium iron phosphate (LFP).

### BACKGROUND

Lithium batteries with LNMCO as a cathode material have many advantages such as high energy density, prominent cycling performance, high voltage plateau, and wide operating temperature range, and lithium batteries with LFP as a cathode material have excellent safety performance and cycling performance, which are widely used in the field of new energy. With the rapid growth in the consumption of lithium-ion batteries (LIBs), the quantity of scrapped LIBs has increased rapidly in recent years. In LNMCO batteries, nickel, cobalt, manganese, and lithium have a high recovery value. In LFP batteries, while a recovery value of phosphorus and iron is not high, these elements will cause ecological environmental pollution if not treated properly. Therefore, the recycling of various battery materials can save a production cost for enterprises, promote the healthy development of the new energy industry, and reduce the pollution of waste battery materials to the environment.

At present, recycling methods for waste LIBs mainly include fire process and wet process. A recycling method based on hydrometallurgy has attracted much attention due to the advantages of high recovery efficiency, simple process, and the like. The existing methods mainly target cathode and anode materials of waste LIBs. The related art discloses a comprehensive recycling method of a waste LIB ternary cathode material, where nickel-lithium and manganese-cobalt are leached out through alkali-leaching and acid-leaching, and then nickel, cobalt, manganese, and lithium are gradually separated, thereby achieving the separate recovery of each element. This method has the advantages of prominent recovery selectivity, environmental friendliness, high recovery rate, and the like. However, a slurry obtained after alkali-leaching is difficult to filter, which may lead to incomplete separation and impure products; and a separation process is relatively cumbersome. The related art also discloses a recycling method, where a waste ternary positive electrode sheet is roasted, dissolved in water, and filtered to obtain a powder with nickel, cobalt, manganese, lithium, and then the LNMCO powder is roasted, dissolved, mixed with a potassium carbonate solution, and filtered to obtain a filter residue; and a carbonate is added to the filter residue to adjust a ratio of lithium, nickel, cobalt, and manganese, and a resulting mixture is ball-milled, compacted, and roasted to obtain an LNMCO cathode material. This method can realize the regeneration of a waste LNMCO cathode material, which is beneficial to resource conservation, cost reduction, and environmental protection. However, the high-temperature reduction roasting involves high energy consumption and has high requirements for equipment and personnel, resulting in difficult industrialization. For the recycling of LFP materials, traditionally, lithium carbonate and phosphorus and iron compounds are prepared through smelting and recycling. This method will cause waste of phosphorus and iron resources and environmental pollution. In addition, the co-precipitation method can also be adopted. For example, a waste LFP material is dissolved in an acid to obtain a mixed solution with lithium ions, ferrous ions, and phosphate ions; and a concentration of each ion and a pH are adjusted to achieve co-precipitation of lithium, iron, and phosphorus to obtain an LFP material. However, the purity and performance of the LFP material obtained by this method need to be improved. In addition, there is a method where lithium carbonate is added to a waste LFP material and a resulting mixture is subjected to sintering and restoration to obtain a new LFP material. This method has high requirements for the morphology and composition of a waste material and has low applicability. Moreover, most of the methods for treating a waste LNMCO material or a waste LFP material currently reported merely target one of the two waste materials, and there are very few methods that can treat a mixed waste material of the two.

Therefore, there is an urgent need to develop a simple and environmentally friendly process that can recycle a mixed waste material of LNMCO and LFP.

### SUMMARY OF THE INVENTION

The present disclosure is intended to solve at least one of the technical problems existing in the prior art. In view of this, the present disclosure provides a recycling method for a mixed waste material of LNMCO and LFP, which is simple and environmentally friendly, can achieve the recovery of all main elements in the mixed waste material of an LNMCO waste material and an LFP waste material and corresponding commercialization, and has promising application prospects.

According to one aspect of the present disclosure, a recycling method for a mixed waste material of LNMCO and LFP is provided, including the following steps:
S1: adding the mixed waste material of LNMCO and LFP to an acid solution for acid-leaching, and conducting solid-liquid separation (SLS) to obtain an acid-leaching liquor;
S2: using a resin to adsorb nickel, cobalt, and manganese in the acid-leaching liquor, and washing a resulting saturated resin with sulfuric acid to obtain a mixed solution of nickel sulfate, cobalt sulfate and manganese sulfate, and a post-adsorption solution;
S3: heating the post-adsorption solution, and adding a lithium-precipitating reagent to obtain a lithium salt precipitate and a post-precipitation solution; and
S4: concentrating the post-precipitation solution, adding a carbon source, and stirring a resulting mixture to obtain a dispersed mixture; and subjecting the dispersed mixture to electrospinning to obtain a sheet material, and drying and roasting the sheet material to obtain a ferric phosphate/carbon material.

In some implementations of the present disclosure, in S1, the acid solution may be one or more from the group consisting of sulfuric acid, nitric acid, and hydrochloric acid. Preferably, the acid solution may be a combination of sulfuric acid and hydrochloric acid or a combination of sulfuric acid and nitric acid.

In some implementations of the present disclosure, in S1, the acid solution may have a concentration of 1 mol/L to 8 mol/L and preferably 1.5 mol/L to 5 mol/L.

In some implementations of the present disclosure, in S1, a mass ratio of the acid solution to the mixed waste material may be (4-10):1 and preferably (5-8):1.

In some implementations of the present disclosure, in S1, the acid-leaching may be conducted at 50° C. to 120° C. and preferably 60° C. to 90° C.; and the acid-leaching may be conducted for 3 h to 10 h and preferably 4 h to 8 h.

In some implementations of the present disclosure, in S2, the resin may be one or more from the group consisting of chelating resin CH-90Na, resin XFS4195, AmberlitelRC748, LonacSR-5, PuroliteS-930, Chelex100, D851, and D402-II. An adsorption principle of the resin: Multi-ligand functional groups on the resin polymer form complexes with metal ions to achieve separation.

In some implementations of the present disclosure, in S2, the absorption may be conducted in an mode of one-stage adsorption or multi-stage adsorption, which has high applicability and leads to a prominent adsorption and separation effect.

In some implementations of the present disclosure, in S2, the obtained mixed solution of nickel sulfate, cobalt sulfate and manganese sulfate may be subjected to precipitation to obtain a ternary precursor.

In some implementations of the present disclosure, in S3, the lithium-precipitating reagent may be one or more from the group consisting of sodium carbonate, sodium phosphate, potassium phosphate, potassium carbonate, sodium oxalate, potassium oxalate, sodium fluoride, potassium fluoride, and ammonium fluoride; and the heating may be conducted at 40° C. to 120° C. and preferably 65° C. to 100° C.

In some implementations of the present disclosure, in S4, the post-precipitation solution may be concentrated until an iron concentration in the post-precipitation solution is 40 g/L to 150 g/L and preferably 50 g/L to 100 g/L. If concentrations of phosphorus and iron in the solution are too low, it is not easy to form filaments during the spinning; and if the concentrations of phosphorus and iron are too high, a needle will be blocked or a spindle will be formed.

In some implementations of the present disclosure, in S4, the carbon source may be one or more from the group consisting of polyvinylpyrrolidone (PVP), polyvinylidene fluoride (PVDF), and polyacrylonitrile (PAN).

In some implementations of the present disclosure, in S4, the carbon source is first dissolved in dimethylformamide (DMF), then a resulting solution is poured into a concentrated post-precipitation solution, and a resulting mixture is stirred to obtain a dispersed mixture. After electrospinning, the DMF is volatilized at a low temperature, and then high-temperature roasting is conducted to make an organic matter decomposed into a carbon material.

In some implementations of the present disclosure, in S4, the drying may be conducted at 40° C. to 90° C. and preferably 40° C. to 70° C. A heating rate should not be too high, otherwise, a filamented texture will collapse.

In some implementations of the present disclosure, in S4, the roasting may be conducted at 250° C. to 600° C. and preferably 300° C. to 550° C. in an air or oxygen atmosphere.

According to a preferred implementation of the present disclosure, the present disclosure at least has the following beneficial effects:

1. The process of the present disclosure can achieve comprehensive recycling of a mixed waste material of LNMCO and LFP. In the process, acid-leaching is conducted to obtain an acid-leaching liquor with nickel, cobalt, manganese, phosphorus, iron, and lithium; adsorption separation is conducted with a resin, the resin is washed with sulfuric acid to obtain a mixed solution of nickel sulfate, cobalt sulfate, and manganese sulfate, and the mixed solution is subjected to precipitation to obtain an LNMCO cathode material precursor; and an obtained solution with phosphorus, iron, and lithium is subjected to lithium precipitation to obtain a lithium salt precipitate, and a post-precipitation solution is subjected to concentration and electrospinning to obtain a ferric phosphate/carbon material, thereby achieving the directed circulation of waste LNMCO and LFP materials.

2. The preparation of ferric phosphate by electrospinning in the present disclosure can reduce the agglomeration in a material, and a prepared material has a fiber network structure, which can increase a specific surface area (SSA) of the material and thus improves the surface performance of the material. Compared with a ferric phosphate material, the ferric phosphate/carbon material has improved electrical conductivity and activity due to the doping of the carbon material, which is beneficial to the growth of an LFP material in the subsequent roasting procedure for preparing the LFP material.

3. The process of the present disclosure is simple and environmentally friendly, has low requirements on equipment, and brings high economic benefits.

### BRIEF DESCRIPTION OF THE DRAWINGS

The present disclosure is further described below with reference to accompanying drawings and examples.

The solethe FIGURE is a process flow diagram of Example 1 of the present disclosure.

### DETAILED DESCRIPTION OF ILLUSTRATED EXAMPLES

The concepts and technical effects of the present disclosure are clearly and completely described below in conjunction with examples, so as to allow the objectives, features and effects of the present disclosure to be fully understood. Apparently, the described examples are merely some rather than all of the examples of the present disclosure. All other examples obtained by those skilled in the art based on the examples of the present disclosure without creative efforts should fall within the protection scope of the present disclosure.

### Example 1

A recycling method for a mixed waste material of LNMCO and LFP was provided, and as shown in the solethe FIGURE, a specific process was as follows:
(1) An LNMCO waste material and an LFP waste material were mixed, crushed, and sieved to obtain a mixed waste material of LNMCO and LFP.
(2) 50 g of the mixed waste material of LNMCO and LFP obtained in step (1) was weighed and added to 250 ml of a sulfuric acid solution with a concentration of 2.5 mol/L in a beaker, then the beaker was placed in a water bath at 80° C., stirring was conducted for 4 h, and a resulting slurry was filtered to obtain a solution with nickel, cobalt, manganese, phosphorus, iron, and lithium and a graphite residue.
(3) A chelating resin CH-90Na was packed in a column, and the solution with nickel, cobalt, manganese, phosphorus, iron, and lithium obtained in step (2) was added dropwise into the resin column using a peristaltic pump; after the resin reached adsorption saturation, a small amount of lithium adhered on a resin surface was washed away with pure water, and then the saturated resin was washed with a 1.5 mol/L sulfuric acid solution to obtain a mixed solution of nickel sulfate, cobalt sulfate, and manganese sulfate, where a post-adsorption solution was a solution with phosphorus, iron, and lithium.
(4) The mixed solution of nickel sulfate, cobalt sulfate, and manganese sulfate obtained in step (3) was subjected to precipitation to obtain a ternary precursor.
(5) The solution with phosphorus, iron, and lithium was heated to 90° C., a sodium carbonate solution was added dropwise for lithium precipitation, and a resulting mixture was filtered to obtain a filter residue; the filter residue was washed with pure water and dried in an oven for 8 h to obtain lithium carbonate; and a lithium content in a post-lithium-precipitation solution was determined, and a lithium recovery rate was calculated.
(6) The post-lithium-precipitation solution obtained in step (5) was concentrated to an iron concentration of 75 g/L; PVP was dissolved in DMF, a resulting solution was poured into the post-lithium-precipitation solution, and a resulting mixture was subjected to dispersion; and electrospinning was conducted to obtain a sheet material, and the sheet material was dried at 60° C. and then roasted at 500° C. to obtain a ferric phosphate/carbon material.

TABLE 1

Calculation results for each component in Example 1

| Item | Ni | Co | Mn | P | Fe | Li |
|---|---|---|---|---|---|---|
| Mass of each component in the raw material (g) | 1.23 | 2.55 | 1.05 | 3.92 | 5.56 | 1.71 |
| Mass of each component in the leaching liquor (g) | 1.21 | 2.51 | 1.04 | 3.88 | 5.51 | 1.69 |
| Leaching rate (%) | 98.37 | 98.43 | 99.05 | 98.98 | 99.10 | 98.83 |
| Mass of each component in the solution obtained after nickel, cobalt, and manganese are precipitated (mg) | 2.01 | 23 | 1.08 | - | - | - |
| Mass of each component in the solution obtained after lithium is precipitated (mg) | 1.11 | 17 | 0.58 | 103.86 | 46.74 | 0.65 |
| Recovery rate (%) | 98.12 | 97.93 | 98.89 | 96.33 | 98.26 | 98.45 |

### Example 2

A recycling method for a mixed waste material of LNMCO and LFP was provided, and a specific process was as follows:
(1) An LNMCO waste material and an LFP waste material were mixed, crushed, and sieved to obtain a mixed waste material of LNMCO and LFP.
(2) 50 g of the mixed waste material of LNMCO and LFP obtained in step (1) was weighed and added to 250 ml of a mixed solution of sulfuric acid and nitric acid that had a concentration of 3.5 mol/L in a beaker, then the beaker was placed in a water bath heated to 90° C., stirring was conducted for 4 h, and a resulting slurry was filtered to obtain a solution with nickel, cobalt, manganese, phosphorus, iron, and lithium and a graphite residue.
(3) A chelating resin CH-90Na was packed in a column, and the solution with nickel, cobalt, manganese, phosphorus, iron, and lithium obtained in step (2) was added dropwise into the resin column using a peristaltic pump; after the resin reached adsorption saturation, a post-adsorption solution was passed through a PuroliteS-930 resin column, a small amount of lithium adhered on a resin surface was washed away with pure water, and then the saturated resin was washed with a 1.5 mol/L sulfuric acid solution to obtain a mixed solution of nickel sulfate, cobalt sulfate, and manganese sulfate, where a post-adsorption solution was a solution with phosphorus, iron, and lithium.
(4) The mixed solution of nickel sulfate, cobalt sulfate, and manganese sulfate obtained in step (3) was subjected to precipitation to obtain a ternary precursor.
(5) The solution with phosphorus, iron, and lithium was heated to 80° C., a potassium carbonate solution was added dropwise for lithium precipitation, and a resulting mixture was filtered to obtain a filter residue; the filter residue was washed with pure water and dried in an oven for 8 h to obtain lithium carbonate; and a lithium content in a post-lithium-precipitation solution was determined, and a lithium recovery rate was calculated.
(6) The post-lithium-precipitation solution obtained in step (5) was concentrated to an iron concentration of 80 g/L; PVDF was dissolved in DMF, a resulting solution was poured into the post-lithium-precipitation solution, and a resulting mixture was subjected to dispersion; and electrospinning was conducted to obtain a sheet material, and the sheet material was dried at 60° C. and then roasted at 450° C. to obtain a ferric phosphate/carbon material.

TABLE 2

Calculation results for each component in Example 2

| Item | Ni | Co | Mn | P | Fe | Li |
|---|---|---|---|---|---|---|
| Mass of each component in the raw material (g) | 1.23 | 2.55 | 1.05 | 3.92 | 5.56 | 1.71 |
| Mass of each component in the leaching liquor (g) | 1.22 | 2.52 | 1.045 | 3.84 | 5.48 | 1.69 |
| Leaching rate (%) | 99.18 | 98.82 | 99.52 | 98.08 | 98.56 | 98.84 |
| Mass of each component in the solution obtained after nickel, cobalt, and manganese are precipitated (mg) | 4.26 | 10.62 | 3.13 | - | - | - |
| Mass of each component in the solution obtained after lithium is precipitated (mg) | 3.08 | 6.04 | 1.84 | 41.66 | 35.64 | 13.55 |
| Recovery rate (%) | 98.59 | 98.17 | 99.05 | 97.02 | 97.92 | 98.33 |

### Example 3

A recycling method for a mixed waste material of LNMCO and LFP was provided, and a specific process was as follows:
(1) An LNMCO waste material and an LFP waste material were mixed, crushed, and sieved to obtain a mixed waste material of LNMCO and LFP.
(2) 50 g of the mixed waste material of LNMCO and LFP obtained in step (1) was weighed and added to 250 ml of a hydrochloric acid solution with a concentration of 4 mol/L in a beaker, then the beaker was placed in a water bath heated to 80° C., stirring was conducted for 6 h, and a resulting slurry was filtered to obtain a solution with nickel, cobalt, manganese, phosphorus, iron, and lithium and a graphite residue.
(4) The mixed solution of nickel sulfate, cobalt sulfate, and manganese sulfate obtained in step (3) was subjected to precipitation to obtain a ternary precursor.
(5) The solution with phosphorus, iron, and lithium was heated to 90° C., a sodium carbonate solution was added dropwise for lithium precipitation, and a resulting mixture was filtered to obtain a filter residue; the filter residue was washed with pure water and dried in an oven for 8 h to obtain lithium carbonate; and a lithium content in a post-lithium-precipitation solution was determined, and a lithium recovery rate was calculated.
(6) The post-lithium-precipitation solution obtained in step (5) was concentrated to an iron concentration of 75 g/L; PVP was dissolved in DMF, a resulting solution was poured into the post-lithium-precipitation solution, and a resulting mixture was subjected to dispersion; and electrospinning was conducted to obtain a sheet material, and the sheet material was dried at 60° C. and then roasted at 400° C. to obtain a ferric phosphate/carbon material.

TABLE 3

Calculation results for each component in Example 3

| Item | Ni | Co | Mn | P | Fe | Li |
|---|---|---|---|---|---|---|
| Mass of each component in the raw material (g) | 1.23 | 2.55 | 1.05 | 3.92 | 5.56 | 1.71 |
| Mass of each component in the leaching liquor (g) | 1.216 | 2.52 | 1.042 | 3.83 | 5.51 | 1.689 |
| Leaching rate (%) | 98.86 | 98.82 | 99.24 | 97.70 | 99.10 | 98.79 |
| Mass of each component in the solution obtained after nickel, cobalt, and manganese are precipitated (mg) | 5.63 | 17.37 | 4.21 | - | - | - |
| Mass of each component in the solution obtained after lithium is precipitated (mg) | 3.74 | 7.45 | 2.49 | 135.24 | 83.4 | 28.38 |
| Recovery rate (%) | 98.10 | 97.85 | 98.60 | 96.55 | 98.50 | 98.34 |

The present disclosure is described in detail with reference to the accompanying drawings and examples, but the present disclosure is not limited to the above examples. Within the scope of knowledge possessed by those of ordinary skill in the technical field, various changes can also be made without departing from the purpose of the present disclosure. In addition, the examples in the present disclosure or features in the examples may be combined with each other in a non-conflicting situation.

1. A recycling method for a mixed waste material of lithium nickel manganese cobalt oxide and lithium iron phosphate, comprising the following steps:
S1: adding the mixed waste material of lithium nickel manganese cobalt oxide and lithium iron phosphate to an acid solution for acid-leaching, and conducting solid-liquid separation to obtain an acid-leaching liquor;
S2: using a resin to adsorb nickel, cobalt, and manganese in the acid-leaching liquor, and washing a resulting saturated resin with sulfuric acid to obtain a mixed solution of nickel sulfate, cobalt sulfate and manganese sulfate, and a post-adsorption solution;
S3: heating the post-adsorption solution, and adding a lithium-precipitating reagent to obtain a lithium salt precipitate and a post-precipitation solution; and
S4: concentrating the post-precipitation solution, adding a carbon source, and stirring to obtain a dispersed mixture; and subjecting the dispersed mixture to electrospinning to obtain a sheet material, and drying and roasting the sheet material to obtain a ferric phosphate/carbon material.

2. The recycling method according to claim 1, wherein in S1, the acid solution is one or more selected from the group consisting of sulfuric acid, nitric acid, and hydrochloric acid.

3. The recycling method according to claim 1, wherein in S1, a mass ratio of the acid solution to the mixed waste material is (4-10):1.

4. The recycling method according to claim 1, wherein in S2, the resin is one or more selected from the group consisting of chelating resin CH-90Na, resin XFS4195, AmberlitelRC748, LonacSR-5, PuroliteS-930, Chelex100, D851, and D402-II.

5. The recycling method according to claim 1, wherein in S2, the obtained mixed solution of nickel sulfate, cobalt sulfate, and manganese sulfate is subjected to precipitation to obtain a ternary precursor.

6. The recycling method according to claim 1, wherein in S3, the lithium-precipitating reagent is one or more selected from the group consisting of sodium carbonate, sodium phosphate, potassium phosphate, potassium carbonate, sodium oxalate, potassium oxalate, sodium fluoride, potassium fluoride, and ammonium fluoride; and the heating is conducted at 40° C. to 120° C.

7. The recycling method according to claim 1, wherein in S4, the post-precipitation solution is concentrated until an iron concentration in the post-precipitation solution is 40 g/L to 150 g/L.

8. The recycling method according to claim 1, wherein in S4, the carbon source is one or more selected from the group consisting of polyvinylpyrrolidone, polyvinylidene fluoride, and polyacrylonitrile.

9. The recycling method according to claim 1, wherein in S4, the carbon source is first dissolved in dimethylformamide to obtain a solution, then the solution is poured into a concentrated post-precipitation solution, and a resulting mixture is stirred to obtain the dispersed mixture.

10. The recycling method according to claim 1, wherein in S4, the drying is conducted at 40° C. to 90° C.; and the roasting is conducted at 250° C. to 600° C.
